(19) United States
(12) Patent Application Publication
(10) Pub. No.: US 2019/0378038 A1
(43) Pub. Date: Dec. 12, 2019

(54) SYSTEMS, METHODS, AND DEVICES FOR THE IDENTIFICATION OF CONTENT CREATORS

(71) Applicant: Social Native, Inc., Beverly Hills, CA (US)

(72) Inventors: David SHADPOUR, Beverly Hills, CA (US); Bhavin DESAI, Beverly Hills, CA (US); Eytan ELBAZ, Beverly Hills, CA (US); Lisa KEOGH, Beverly Hills, CA (US); Steven OXLEY, Beverly Hills, CA (US)

(21) Appl. No.: 16/435,419

(22) Filed: Jun. 7, 2019

Related U.S. Application Data
(60) Provisional application No. 62/701,401, filed on Jul. 20, 2018.
(60) Provisional application No. 62/682,745, filed on Jun. 8, 2018.

(51) Int. Cl. G06N 20/00; G06F 9/451

(52) U.S. Cl. CPC G06N 20/00; G06F 9/451

(57) ABSTRACT

Described herein are systems, methods, and devices for scoring digital content creators and their creations. The systems, methods, devices describe herein enable the content buyers to describe a desired work product and find the ideal content creator for the project.

### CROSS-REFERENCE

This application claims the benefit of U.S. Provisional Application No. 62/682,745, filed Jun. 8, 2018, and U.S. Provisional Application No. 62/701,401, filed Jul. 20, 2018, both of which are hereby incorporated by reference in its entirety herein.

### BACKGROUND OF THE INVENTION

Digital media creators are continually working to create advertisements, information sources and social media to aid companies in disseminating information and marketing products.

### SUMMARY OF THE INVENTION

Digital media content providers are faced with many potential problems when finding personnel to create media. Often, the creation of digital media requires that the creator not only be a skilled artist, but also a skilled computer software user. Given the type of media being created, the creator may also benefit from other traits, such as gender, age, social class, geographic location, ideology, personality, etc. For example, if the digital media content provider was contracted to produce an advertisement to place on the packaging of a children's toy that propels soft darts, the content provider seeks to find the ideal candidate to produce the work or digital media. Currently, a content provider might need to rely on past experience or intuition, rather than data analytics, for the selection process. In this case, the content provider may select a young male creator rather than a more qualified and experienced creator, simply because content provider has limited data and must act on intuition.

Prior technologies suffer from the ability to accurately identify and match content creators with a user's request for media generation. The subject matter, among other items, offers an improved technological tool in the form of a machine learning algorithm trained via supervised learning to more accurately identify and match the most appropriate content creator with a given user's request for media generation. One of the exemplary features of the subject matter is the use of an expanded training set of categories to train the machine learning comprising an internal content rating category; an internal creator rating category, an external creator rating category; an external content rating category; a content performance category; a crowd-sourced content rating category; a reliability score category; a crowd-sourced interest mapping category; an internal interest mapping category; a creator social metric category; a content score; a creator score; an interest graph; a content type score; or any combination thereof. In some embodiments, the trained machine learning algorithm provides a predicted list of ideal content creators for a given user request for media generation. In some embodiments, the user selects one or more content creators from the predicted list. In some embodiments, the user selection is fed back into the machine learning to improve the identification and matching of future content creators with similar users for similar media generation.

The systems, methods, and devices described herein are used to gather data regarding the work product and performance of individual content creators over time, evaluate said data, provide to the user an interface for inputting proposed new project data, and provide to the user a list of possible creator matches for said proposed project, sorted by matchmaking scores. By utilizing the systems, methods, and devices described herein, the digital media content provider can rely on data analytics to aid in the determination and matchmaking of ideal candidates with specific content creation.

Described herein, in certain embodiments, is a computer-implemented system comprising: a digital processing device comprising: at least one processor, an operating system configured to perform executable instructions, a memory, and a computer program including instructions executable by the digital processing device to optimize a computer's effectiveness in identifying content creators comprising: a) a software module configured to receive a request for media generation; b) a software module configured to receive a plurality of content creator data; c) an identification module that applies a machine learning algorithm to process the request for media generation and the plurality of content creator data to identify one or more content creators to perform the request for media generation; d) a validation module that receives identification data following generation of the requested media by the identified content creator; and e) an optimization module that feeds back the identification data into the identification module to improve the machine learning algorithm. Described herein, in certain embodiments, is a computer-implemented system the request for media generation is a request for the generation of any form of media. Described herein, in certain embodiments, is a computer-implemented system wherein the request for media generation comprises one or more of the following: a description of the media, the interests which the media intends to target, the demographic which the media intends to target, and the required content type. Described herein, in certain embodiments, is a computer-implemented system wherein the content creator data comprises one or more of the following: a creator score, an interest graph, and a content type score. Described herein, in certain embodiments, is a computer-implemented system wherein the creator score comprises one or more of the following: a content score, an internal creator score, an external creator score, creator social metrics and a reliability score. Described herein, in certain embodiments, is a computer-implemented system wherein the content score comprises one or more of the following: an internal content rating, an external content rating, content performance data, and a crowd sourced content rating. Described herein, in certain embodiments, is a computer-implemented system wherein the interest graph comprises one or more of the following: crowd sourced interest mapping and internal interest mapping. Described herein, in certain embodiments, is a computer-implemented system wherein the content type score comprises one or more of the following: an internal content rating, an external content rating, and a crowd sourced content rating. Described herein, in certain embodiments, is a computer-implemented system wherein the machine learning algorithm uses an aggregate of two or more the following parameters to identify a content creator: creator score, interest graph, content type score, content score, internal creator score, external creator score, creator social metrics, reliability score, internal content rating, external content rating, content performance data, crowd sourced content rating, crowd sourced interest mapping, and internal interest mapping, wherein each term is variably weighted. Described herein, in certain embodiments, is a computer-implemented system wherein the machine learning algorithm uses an aggregate of the following parameters to identify a content creator: creator score, interest graph and content type score, wherein each term is variably weighted.

Described herein, in certain embodiments, is a computer-implemented system wherein a plurality of content creators are identified. Described herein, in certain embodiments, is a computer-implemented system wherein the plurality of content creators are ranked according to one or more of the following parameters: creator score, interest graph, content type score, content score, internal creator score, external creator score, creator social metrics, reliability score, internal content rating, external content rating, content performance data, crowd sourced content rating, crowd sourced interest mapping, and internal interest mapping. Described herein, in certain embodiments, is a computer-implemented system wherein the plurality of content creators are ranked according to one of the following parameters: creator score, interest graph, content type score, content score, internal creator score, external creator score, creator social metrics, reliability score, internal content rating, external content rating, content performance data, crowd sourced content rating, crowd sourced interest mapping, and internal interest mapping. Described herein, in certain embodiments, is a computer-implemented system wherein the plurality of content creators are ranked according an aggregate of the following parameters creator score, interest graph, content type score, content score, internal creator score, external creator score, creator social metrics, reliability score, internal content rating, external content rating, content performance data, crowd sourced content rating, crowd sourced interest mapping, and internal interest mapping, wherein each parameters is variably weighted. Described herein, in certain embodiments, is a computer-implemented system wherein the plurality of content creators are ranked according an aggregate of the following parameters: creator score, interest graph and content type score, wherein each parameters is variably weighted. Described herein, in certain embodiments, is a computer-implemented system wherein the identification data comprises one or more of the following: the selection of an identified content creator for media generation, the non-selection of an identified content creator for media generation, and any content creator data generated as a result of a selected content creator generating media in response to a request for media generation. Described herein, in certain embodiments, is a computer-implemented system wherein the content creator data generated as a result of new media generation comprises one or more of the following: creator score, interest graph, content type score, content score, internal creator score, external creator score, creator social metrics, reliability score, internal content rating, external content rating, content performance data, crowd sourced content rating, crowd sourced interest mapping, and internal interest mapping. Described herein, in certain embodiments, is a computer-implemented system wherein the content creator data generated as a result of new media generation comprises one or more of the following: content score, internal creator score, external creator score, internal content rating, external content rating, content performance data, and crowd sourced content rating.

Described herein, in certain embodiments, is a computer-implemented method of identifying content creators comprising: a) receiving, by a computer a request for media generation; b) receiving, by a computer a plurality of content creator data; c) applying a machine learning identification algorithm to process the request for media generation and the plurality of content creator data to identify one or more content creators to perform the request for media generation; d) receiving, by a computer identification data following generation of the requested media by the identified content creator; and e) optimizing the machine learning identification algorithm by feeding back the identification data into the machine learning identification algorithm. Described herein, in certain embodiments, is a computer-implemented method wherein the request for media generation is a request for the generation of any form of media. Described herein, in certain embodiments, is a computer-implemented method wherein the request for media generation comprises one or more of the following: a description of the media, the interests which the media intends to target, the demographic which the media intends to target, and the required content type. Described herein, in certain embodiments, is a computer-implemented method wherein the content creator data comprises one or more of the following: a creator score, an interest graph, and a content type score. Described herein, in certain embodiments, is a computer-implemented method wherein the creator score comprises one or more of the following: a content score, an internal creator score, an external creator score, creator social metrics, and a reliability score. Described herein, in certain embodiments, is a computer-implemented method wherein the content score comprises one or more of the following: an internal content rating, an external content rating, content performance data, and a crowd sourced content rating. Described herein, in certain embodiments, is a computer-implemented method wherein the interest graph comprises one or more of the following: crowd sourced interest mapping and internal interest mapping. Described herein, in certain embodiments, is a computer-implemented method wherein the content type score comprises one or more of the following: an internal content rating, an external content rating, and a crowd sourced content rating. Described herein, in certain embodiments, is a computer-implemented method wherein the machine learning algorithm uses an aggregate of two or more the following parameters to identify a content creator: creator score, interest graph, content type score, content score, internal creator score, external creator score, creator social metrics, reliability score, internal content rating, external content rating, content performance data, crowd sourced content rating, crowd sourced interest mapping, and internal interest mapping, wherein each term is variably weighted. Described herein, in certain embodiments, is a computer-implemented method wherein the machine learning algorithm uses an aggregate of the following parameters to identify a content creator: creator score, interest graph and content type score, wherein each term is variably weighted. Described herein, in certain embodiments, is a computer-implemented method wherein a plurality of content creators are identified. Described herein, in certain embodiments, is a computer-implemented method wherein the plurality of content creators are ranked according to one or more of the following parameters: creator score, interest graph, content type score, content score, internal creator score, external creator score, creator social metrics, reliability score, internal content rating, external content rating, content performance data, crowd sourced content rating, crowd sourced interest mapping, and internal interest mapping. Described herein, in certain embodiments, is a computer-implemented method wherein the plurality of content creators are ranked according to one of the following parameters: creator score, interest graph, content type score, content score, internal creator score, external creator score, creator social metrics, reliability score, internal content rating, external content rating, content performance data, crowd sourced content rating, crowd sourced interest mapping, and internal interest mapping. Described herein, in certain embodiments, is a computer-implemented method wherein the plurality of content creators are ranked according an aggregate of the following parameters creator score, interest graph, content type score, content score, internal creator score, external creator score, creator social metrics, reliability score, internal content rating, external content rating, content performance data, crowd sourced content rating, crowd sourced interest mapping, and internal interest mapping, wherein each parameters is variably weighted. Described herein, in certain embodiments, is a computer-implemented method wherein the plurality of content creators are ranked according an aggregate of the following parameters: creator score, interest graph and content type score, wherein each parameters is variably weighted. Described herein, in certain embodiments, is a computer-implemented method wherein the identification data comprises one or more of the following: the selection of an identified content creator for media generation, the non-selection of an identified content creator for media generation, and any content creator data generated as a result of a selected content creator generating media in response to a request for media generation. Described herein, in certain embodiments, is a computer-implemented method wherein the content creator data generated as a result of new media generation comprises one or more of the following: creator score, interest graph, content type score, content score, internal creator score, external creator score, creator social metrics, reliability score, internal content rating, external content rating, content performance data, crowd sourced content rating, crowd sourced interest mapping, and internal interest mapping. Described herein, in certain embodiments, is a computer-implemented method wherein the content creator data generated as a result of new media generation comprises one or more of the following: content score, internal creator score, external creator score, internal content rating, external content rating, content performance data, and crowd sourced content rating.

Described herein, in certain embodiments, is a non-transitory computer-readable storage media encoded with a computer program including instructions executable by a processor to create to optimize a computer's effectiveness in identifying content creators comprising: a) a software module configured to receive a request for media generation; b) a software module configured to receive a plurality of content creator data; c) an identification module that applies a machine learning algorithm to process the request for media generation and the plurality of content creator data to identify one or more content creators to perform the request for media generation; d) a validation module that receives identification data following generation of the requested media by the identified content creator; and e) an optimization module that feeds back the identification data into the identification module to improve the machine learning algorithm. Described herein, in certain embodiments, is a non-transitory computer-readable storage media wherein the request for media generation is a request for the generation of any form of media. Described herein, in certain embodiments, is a non-transitory computer-readable storage media wherein the request for media generation comprises one or more of the following: a description of the media, the interests which the media intends to target, the demographic which the media intends to target, and the required content type. Described herein, in certain embodiments, is a non-transitory computer-readable storage media wherein the content creator data comprises one or more of the following: a creator score, an interest graph, and a content type score. Described herein, in certain embodiments, is a non-transitory computer-readable storage media wherein the creator score comprises one or more of the following: a content score, an internal creator score, an external creator score, creator social metrics, and a reliability score. Described herein, in certain embodiments, is a non-transitory computer-readable storage media wherein the content score comprises one or more of the following: an internal content rating, an external content rating, content performance data, and a crowd sourced content rating. Described herein, in certain embodiments, is a non-transitory computer-readable storage media wherein the interest graph comprises one or more of the following: crowd sourced interest mapping and internal interest mapping. Described herein, in certain embodiments, is a non-transitory computer-readable storage media wherein the content type score comprises one or more of the following: an internal content rating, an external content rating, and a crowd sourced content rating. Described herein, in certain embodiments, is a non-transitory computer-readable storage media wherein the machine learning algorithm uses an aggregate of two or more the following parameters to identify a content creator: creator score, interest graph, content type score, content score, internal creator score, external creator score, creator social metrics, reliability score, internal content rating, external content rating, content performance data, crowd sourced content rating, crowd sourced interest mapping, and internal interest mapping, wherein each term is variably weighted. Described herein, in certain embodiments, is a non-transitory computer-readable storage media wherein the machine learning algorithm uses an aggregate of the following parameters to identify a content creator: creator score, interest graph and content type score, wherein each term is variably weighted. Described herein, in certain embodiments, is a non-transitory computer-readable storage media wherein a plurality of content creators are identified. Described herein, in certain embodiments, is a non-transitory computer-readable storage media wherein the plurality of content creators are ranked according to one or more of the following parameters: creator score, interest graph, content type score, content score, internal creator score, external creator score, creator social metrics, reliability score, internal content rating, external content rating, content performance data, crowd sourced content rating, crowd sourced interest mapping, and internal interest mapping. Described herein, in certain embodiments, is a non-transitory computer-readable storage media wherein the plurality of content creators are ranked according to one of the following parameters: creator score, interest graph, content type score, content score, internal creator score, external creator score, creator social metrics, reliability score, internal content rating, external content rating, content performance data, crowd sourced content rating, crowd sourced interest mapping, and internal interest mapping. Described herein, in certain embodiments, is a non-transitory computer-readable storage media wherein the plurality of content creators are ranked according an aggregate of the following parameters creator score, interest graph, content type score, content score, internal creator score, external creator score, creator social metrics, reliability score, internal content rating, external content rating, content performance data, crowd sourced content rating, crowd sourced interest mapping, and internal interest mapping, wherein each parameters is variably weighted. Described herein, in certain embodiments, is a non-transitory computer-readable storage media wherein the plurality of content creators are ranked according an aggregate of the following parameters: creator score, interest graph and content type score, wherein each parameters is variably weighted.

Described herein, in certain embodiments, is a non-transitory computer-readable storage media wherein the identification data comprises one or more of the following: the selection of an identified content creator for media generation, the non-selection of an identified content creator for media generation, and any content creator data generated as a result of a selected content creator generating media in response to a request for media generation. Described herein, in certain embodiments, is a non-transitory computer-readable storage media wherein the content creator data generated as a result of new media generation comprises one or more of the following: creator score, interest graph, content type score, content score, internal creator score, external creator score, creator social metrics, reliability score, internal content rating, external content rating, content performance data, crowd sourced content rating, crowd sourced interest mapping, and internal interest mapping. Described herein, in certain embodiments, is a non-transitory computer-readable storage media wherein the content creator data generated as a result of new media generation comprises one or more of the following: content score, internal creator score, external creator score, internal content rating, external content rating, content performance data, and crowd sourced content rating.

Another aspect provided herein is a method for adaptive identifying content creators data selection through a network appliance connected between computing devices in a network, the method comprising: collecting, from a content creator, by the network appliance, a crowd-sourced content rating, collecting from an internal editor, by the network appliance, an internal content rating, and an internal creator rating; collecting from an brand user, by the network appliance, an external content rating and an external creator rating; determining, by the computer device, a content performance, a reliability score, and a creator social metric based on a social media data; calculating, by the computer device, a content score based on the internal content rating, the external content rating, the content performance, and the crowd-sourced content rating; calculating, by the computer device, a creator score based on the content score, the internal creator rating, the external creator rating, the reliability score, and the creator social metric; collecting at least one of additional crowd-sourced content ratings, internal content ratings, internal creator ratings, external content ratings, and the external creator ratings if at least one of the content score and the creator score are below a first predefined threshold.

In some embodiments, at least one of the internal creator rating and the external creator rating are associated with a creator profile. In some embodiments, at least one of the crowd-sourced content rating, internal content rating, external content rating, are associated with a creator profile are associated with a content of a campaign. In some embodiments, the method further comprises collecting from a content creator, by the network appliance, at least one of a crowd sourced interest map and an internal interest map. In some embodiments, the method further comprises calculating an interest graph from at least one of the crowd sourced interest map and the internal interest map. In some embodiments, the method further comprises collecting at least one of additional crowd-sourced content ratings, internal content ratings, internal creator ratings, external content ratings, and the external creator ratings if the interest graph is below a second predefined threshold. In some embodiments, the method further comprises calculating a content type score from at least one of the internal content rating, the external content rating, and the crowd-sourced content rating. In some embodiments, the method further comprises collecting at least one of additional crowd-sourced content ratings, internal content ratings, internal creator ratings, external content ratings, and the external creator ratings if the content type score is below a third predefined threshold.

Another aspect provided herein is a method of rearranging content and creator icons on a graphical user interface (GUI) of a computer system, the method comprising: collecting from a content creator, via the GUI, a crowd-sourced content rating associated with a content of a campaign; collecting from an internal editor, via the GUI, an internal content rating associated with the content of the campaign, and an internal creator rating associated with the creator; collecting from an brand user, via the GUI, an external content rating associated with the content of the campaign and an external creator rating associated with the creator; determining, by the computer system, a content performance, a reliability score, and a creator social metric based on a social media data; calculating, by the computer system, a content score based on the internal content rating, the external content rating, the content performance, and the crowd-sourced content rating; and calculating, by the computer system, a creator score based on the content score, the internal creator rating, the external creator rating, the reliability score, and the creator social metric; automatically arranging an icon associated with the content creator and an icon associated with the content of the campaign based on the content score, the creator score, or both.

In some embodiments, the method further comprises collecting from a content creator, via the GUI, at least one of a crowd sourced interest map and an internal interest map. In some embodiments, the method further comprises calculating an interest graph from at least one of the crowd sourced interest map and the internal interest map. In some embodiments, the method further comprises collecting at least one of additional crowd-sourced content ratings, internal content ratings, internal creator ratings, external content ratings, and the external creator ratings if the interest graph is below a second predefined threshold. In some embodiments, the method further comprises calculating a content type score from at least one of the internal content rating, the external content rating, and the crowd-sourced content rating. In some embodiments, the method further comprises collecting at least one of additional crowd-sourced content ratings, internal content ratings, internal creator ratings, external content ratings, and the external creator ratings if the content type score is below a third predefined threshold.

Another aspect provided herein is a method for adaptive identifying content creators data selection through a network appliance connected between computing devices in a network, the method comprising: receiving, by the network appliance, an internal content rating (A), an internal creator rating (B), an external creator rating (C), an external content rating (D), and a crowd-sourced content rating (E); determining, by a first computer device, a content performance (F), a reliability score (G), and a creator social metric (H) based on a social media data; calculating, a content score (I), wherein I=X₁*A+X₂*D+X₃*E+X₄*F, wherein X₁, X₂, X₃, and X₄ are content score weights; calculating, a creator score (J), wherein J=Y₁*I+Y₂*B+Y₃*C+Y₄*G+Y₅*H, wherein Y₁, Y₂, Y₃, Y₄, and Y₅ are creator score weights; and transmitting the content score and the creator score to a second computer device.

In some embodiments, at least one of the internal creator rating and the external creator rating are associated with a creator profile. In some embodiments, at least one of the crowd-sourced content rating, internal content rating, external content rating, are associated with a creator profile are associated with a content of a campaign. In some embodiments, the method further comprises receiving by the network appliance a crowd sourced interest map (K) and an internal interest map (L). In some embodiments, the method further comprises calculating an interest graph (M) from at least one of the crowd sourced interest map (N) and the internal interest map (O), wherein M=Z₁*N+Z₂*O and wherein Z₁ and Z₅ are interest graph weights. In some embodiments, the method further comprises calculating a content type score (P) from at least one of the internal content rating (A), the external content rating (D), and the crowd-sourced content rating (E), wherein P=Q₁*A+Q₂*D+Q₃*E and wherein Q₁, Q₂, and Q₃ are content type score weights.

Another aspect provided herein is a computer-implemented system comprising: a computer-readable storage device coupled to the at least one processor and having instructions stored thereon which, when executed by the at least one processor, cause the at least one processor to perform operations comprising: receiving, from a user interface, a request for media generation; determining a plurality of content creators based on the request for media generation; training a machine learning algorithm using the plurality of content creators; receiving, from a user interface, a selection of one or more selected content creators of the content creators of the plurality of content creators; assigning unrefined weights to a predictor variable of the machine learning algorithm; processing the request for media generation through the machine learning algorithm to determine a plurality of recommended options, the recommended options comprising one or more content creators; providing the recommended options to the user interface; receiving, from the user interface, a data set comprising selections of the one or more content creators; adjusting the predictor variables of the machine learning algorithm based on the selections of the one or more content creators; feeding back the data set, and the request for media generation through the machine learning algorithm to improve the ability of the machine learning algorithm to determine a plurality of recommended options.

In some embodiments, the request for media generation is a request for the generation of any form of media. In some embodiments, the request for media generation comprises one or more of the following: a description of the media, the interests which the media intends to target, the demographic which the media intends to target, and a required content type. In some embodiments, each of the plurality of content creators are associated with a content creator data comprising one or more of a creator score, and an interest graph. In some embodiments, the creator score comprises one or more of the following: a content score, an internal creator score, an external creator score, creator social metrics and a reliability score. In some embodiments, the interest graph comprises one or more of the following: crowd sourced interest mapping and internal interest mapping. In some embodiments, the predictor variables comprise weights associated with the content creator data. In some embodiments, the request for media generation is associated with a content score. In some embodiments, the content score comprises one or more of the following: an internal content rating, an external content rating, content performance data, and a crowd sourced content rating. In some embodiments, the predictor variables comprise weights associated with the content score.

Another aspect provided herein is a computer-implemented method of training a machine learning algorithm for identifying content creators comprising: collecting a plurality of content creator data and a plurality of requests for media generation, wherein each request for media generation is associated with a selected creator data; create a first training set comprising the plurality of selected content creator data, the plurality of requests for media generation, and a plurality of non-selected content creator data; training the machine learning algorithm in a first stage using the first training set; create a second training set comprising the first training set and the non-selected content creator data that are incorrectly identified as a selected content creator training the neural network in a second stage using the second training set;

The system of claim 11, wherein the request for media generation is a request for the generation of any form of media. In some embodiments, the request for media generation comprises one or more of the following: a description of the media, the interests which the media intends to target, the demographic which the media intends to target, and a required content type. In some embodiments, each of the plurality of content creators are associated with a content creator data comprising one or more of a creator score, and an interest graph. In some embodiments, the creator score comprises one or more of the following: a content score, an internal creator score, an external creator score, creator social metrics and a reliability score. In some embodiments, the interest graph comprises one or more of the following: crowd sourced interest mapping and internal interest mapping. In some embodiments, the predictor variables comprise weights associated with the content creator data. In some embodiments, the request for media generation is associated with a content score. In some embodiments, the content score comprises one or more of the following: an internal content rating, an external content rating, content performance data, and a crowd sourced content rating. In some embodiments, the predictor variables comprise weights associated with the content score.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a non-limiting example of the data and scoring system used to evaluate content creators and their work product;

FIG. 2 shows a non-limiting example of the matchmaking process between a new media project and a specific content creator;

FIG. 3 shows a non-limiting example of an interface for selecting a reason for an external creator rating; according to some embodiments herein;

FIG. 4 shows a non-limiting example of an interface for selecting the external content rating, according to some embodiments herein;

FIG. 5 shows a non-limiting example of an interface for selecting the external creator rating, according to some embodiments herein;

FIG. 6 shows a non-limiting example of an interface for selecting the rating of an internal content rating, according to some embodiments herein;

FIG. 7 shows a non-limiting example of an interface for selecting the internal content rating, according to some embodiments herein;

FIG. 8 shows a non-limiting example of an interface for viewing content performance data, according to some embodiments herein;

FIG. 9 shows a non-limiting example of an interface for selecting a crowd sourced content rating, according to some embodiments herein;

FIG. 10 shows a non-limiting example of an interface for selecting a reason for a crowd sourced content rating, according to some embodiments herein;

FIG. 11 shows a non-limiting example of an interface for selecting the crowd-sourced interest mapping, according to some embodiments herein;

FIG. 12 shows a non-limiting example of an interface for displaying a reliability score, according to some embodiments herein;

FIG. 13 shows a non-limiting example of an interface for selecting an internal interest, according to some embodiments herein;

FIG. 14 shows a non-limiting example of a computing device; in this case, a device with one or more processors, memory, storage, and a network interface;

FIG. 15 shows a non-limiting example of a web/mobile application provision system; in this case, a system providing browser-based and/or native mobile user interfaces; and

FIG. 16 shows a non-limiting example of a cloud-based web/mobile application provision system; in this case, a system comprising an elastically load balanced, auto-scaling web server and application server resources as well synchronously replicated databases.

### DETAILED DESCRIPTION OF THE INVENTION

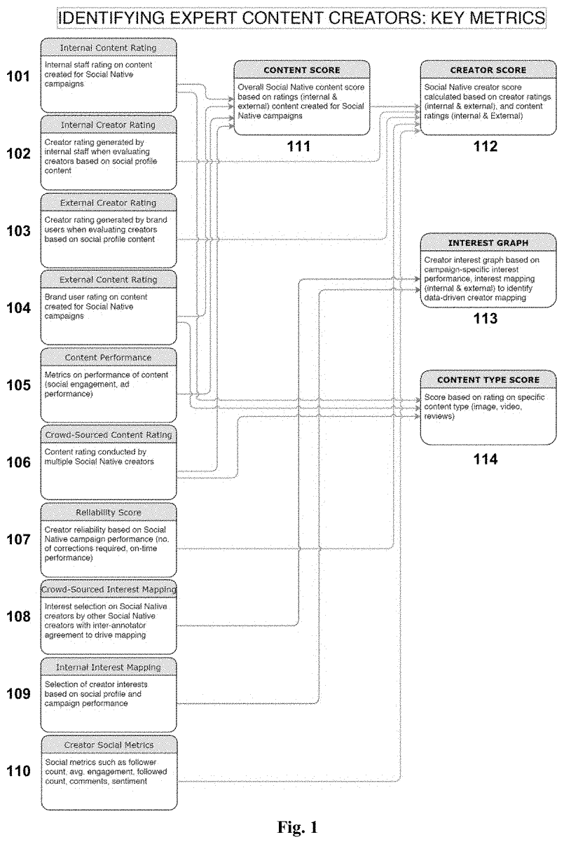

Described herein, in certain embodiments, are systems, methods, and devices used to identify skilled content creators, and match them with buyers of custom content, (“Buyers”). In some embodiments, the systems, methods, and devices used herein utilize various sources of information in the matchmaking process. FIG. 1 identifies exemplary key metrics used to identify content creators.

### Identification of Content Creators

In order to identify the best content creators, the methods and systems herein utilize, in some embodiments, multiple sources of information, scores and aggregate scores.

In some embodiments, the systems, methods, and devices used herein utilize an internal content rating score (101) comprising a score received by a system author regarding an individual piece of content on a numerical scale. In some embodiments, the numerical scale is a scale from 1-3, 1-5, or 1-10. In some embodiments, the internal content rating score (101) is based on a variety of factors including, but not limited to, aesthetics, creativity, composition, and adherence to guidelines.

In some embodiments, the systems, methods, and devices used herein utilize an internal creator rating score (102) comprising a score received by a system author regarding a creator on a numerical scale. In some embodiments, the numerical scale is a scale from 1-3, 1-5, or 1-10. In some embodiments, the internal creator rating score (102) is based on a variety of factors including, but not limited to, social reach and engagement, and social profile content.

In some embodiments, the systems, methods, and devices used herein utilize an external creator rating score (103) comprising a score received by a brand user regarding a creator on a numerical scale. In some embodiments, the numerical scale is a scale from 1-3, 1-5, or 1-10. In some embodiments, the external creator rating score (103) is based on a variety of factors including, but not limited to, aesthetics, creativity, composition, social profile content, and adherence to guidelines.

In some embodiments, the systems, methods, and devices used herein utilize an external content rating score (104), comprising a score received by a brand user regarding an individual content on a numerical scale. In some embodiments, the numerical scale is a scale from 1-3, 1-5, or 1-10. In some embodiments, the external content rating score (104) is based on a variety of factors including, but not limited to, social reach and engagement.

In some embodiments, the systems, methods, and devices used herein utilize a content performance score (105), comprising numerical performance metrics on the engagement of custom content from social media platform. In some embodiments, the numerical scale is a scale from 1-3, 1-5, or 1-10. In some embodiments, the content performance score (105) is received via an application program interface (API). Content performance scores (105) include reach, engagement (made of comment ratio, like ratio, share ratio), click-through rate, ad performance, and conversion rate.

In some embodiments, the systems, methods, and devices used herein utilize a crowd-sourced content rating score (106), comprising a score received by another creator regarding an individual content on a numerical scale. In some embodiments, the numerical scale is a scale from 1-3, 1-5, or 1-10. In some embodiments, the crowd-sourced content rating score (106) is based on a variety of factors including, but not limited to, aesthetics, creativity, composition, and adherence to guidelines.

In some embodiments, the systems, methods, and devices used herein utilize a reliability score (107), comprising a score determined by campaign performance a numerical scale. In some embodiments, the numerical scale is a scale from 1-3, 1-5, or 1-10. In some embodiments, the reliability score (107) is based on, but not limited to, adherence to guidelines, timeliness of content creation, content timeliness, and the number of required iterations to create approved content.

In some embodiments, the systems, methods, and devices used herein utilize a crowd-sourced interest mapping score (108), wherein the crowd-sourced interest mapping score comprises scores received by other creators regarding a creator based on data gathered from social content, bio, descriptions and commentary generated by the creators work.

In some embodiments, the systems, methods, and devices used herein utilize an internal interest mapping score (109), comprising an interest selected by or assigned to a creator based on perceived creator interests, social content, bio, descriptions, and commentary generated by the creators work.

In some embodiments, the systems, methods, and devices used herein utilize an internal creator social metric (110), wherein the creator social metric comprises third parties interaction with a creator's media. In some embodiments, the creator social metric comprises social media follower count, a creators engagement in social media, social media generated as a result of the creator or the creators work, comments generated as a result of the creator or the creators work, or sentiment related to the creator or the creators work.

In some embodiments, a Content Score (111) is used as a scoring aggregate to aid in matchmaking. In some embodiments, the Content Score is calculated as follows: Content Score=A (Internal Content Rating)*/+B (External Content Rating)*/+C (Content Performance)*/+D (Crowd-Sourced Content Rating). Each individual piece of content on the system gets its own Content Score and is updated as new content ratings are received.

In some embodiments, a creator score (112) is used as a scoring aggregate to aid in matchmaking. In some embodiments, the creator score is calculated as follows: Creator Score=A (Content Score)*/+B (Internal Creator Rating)*/+C (External Creator Rating)*/+D (Reliability Score). Each individual creator on the system has its own creator score that gets updated as new content is created and new ratings are received.

In some embodiments, an interest graph (113) is created. In some embodiments, the interest graph is a set of individual interest scores. For example, a creator may have a score of 8.7 for pets, and 6.5 for DIY, and 4.3 beauty, and 4.2 for fitness. In some embodiments, an Interest Score is calculated as follows: Interest Score=A (Crowd-Source Interest Mapping)*/+B (Internal Interest mapping).

In some embodiments, a content type mapping is created. In some embodiments, the content type mapping is a set of content type scores (114). In some embodiments, each content type (e.g. image, short-form video, long-form video, reviews, animated GIF,) is given a score based on A (Internal Content Rating)*/+B (External Content Rating)*/+C (Content Performance)*/+D (Crowd-sourced Content Rating)

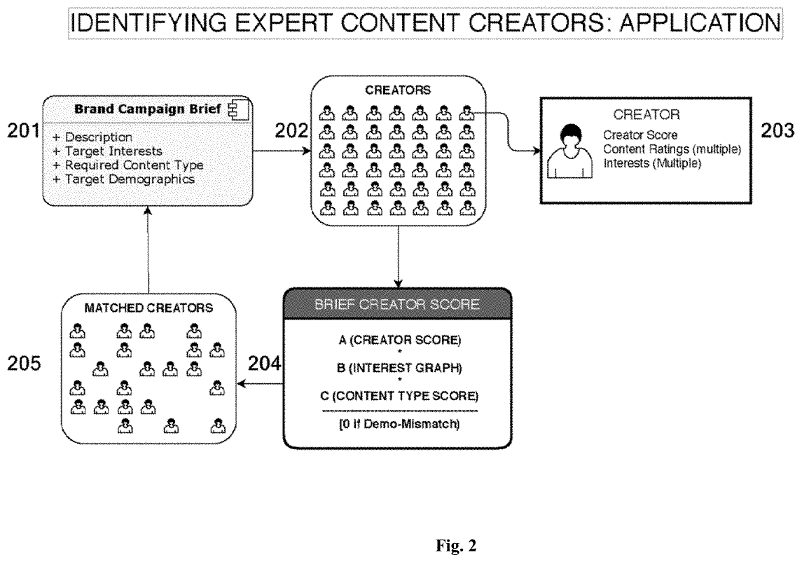

In some embodiments, the process of matchmaking is described in FIG. 2. In the process, a buyer will create a brief which contains a description (text form explanation for the content they wish to purchase), target interests (the type of audience), required content type (e.g. image, short-form video, long-form video, reviews, animated GIF), and target demographics (age, gender, location) (201). In some embodiments, the system author has collected data for use in the determination of creators' ratings (202). For example, in one embodiment, each content creator has an associated creator score, interest graph and content type score (203). In some embodiments, the system computes a brief creator score using the following formula: Brief Creator Score=A (Creator Score)*/+B (Interest Graph)*/+C (Content Type Score) (204). The Brief Creator Score is 0 if the specified demographics do not match the creator's demographics. In some embodiments, the system ranks each of the creators by the Brief Creator Score in descending order. The system applies a filter for the best matched creators by selecting either a top percentage or top # of creators or a predetermined threshold for the brief based on how much content is required in the Brief (205).

In some embodiments, the systems and methods herein collect at least one of additional crowd-sourced content ratings, internal content ratings, internal creator ratings, external content ratings, and the external creator ratings if at least one of the content score and the creator score are below a first predefined threshold. In some embodiments, the systems and methods herein collect at least one of additional crowd-sourced content ratings, internal content ratings, internal creator ratings, external content ratings, and the external creator ratings if the interest graph is below a second predefined threshold. In some embodiments, the systems and methods herein collect at least one of additional crowd-sourced content ratings, internal content ratings, internal creator ratings, external content ratings, and the external creator ratings if the content type score is below a third predefined threshold. In some embodiments, at least one of the first predefined threshold, the second predefined threshold, and the third predefined threshold comprise a score of about 10%, 20%, 30%, 40%, 50%, 60%, 70%, 80%, or more including increments therein. In some embodiments, at least one of the first predefined threshold, the second predefined threshold, and the third predefined threshold is determined by a machine learning algorithm based on at least one of additional crowd-sourced content ratings, internal content ratings, internal creator ratings, external content ratings, and the external creator ratings.

In some embodiments, machine learning algorithms are utilized to aid in creator performance evaluation. In some embodiments, machine learning algorithms are utilized to aid in creator content evaluation. In some embodiments, machine learning algorithms are utilized to aid in new project evaluation. In some embodiments, machine learning algorithms are used utilized to aid in matching a content creator with a new project.

Examples of machine learning algorithms may include a support vector machine (SVM), a naïve Bayes classification, a random forest, a neural network, deep learning, or other supervised learning algorithm or unsupervised learning algorithm for classification and regression. The machine learning algorithms may be trained using one or more training datasets.

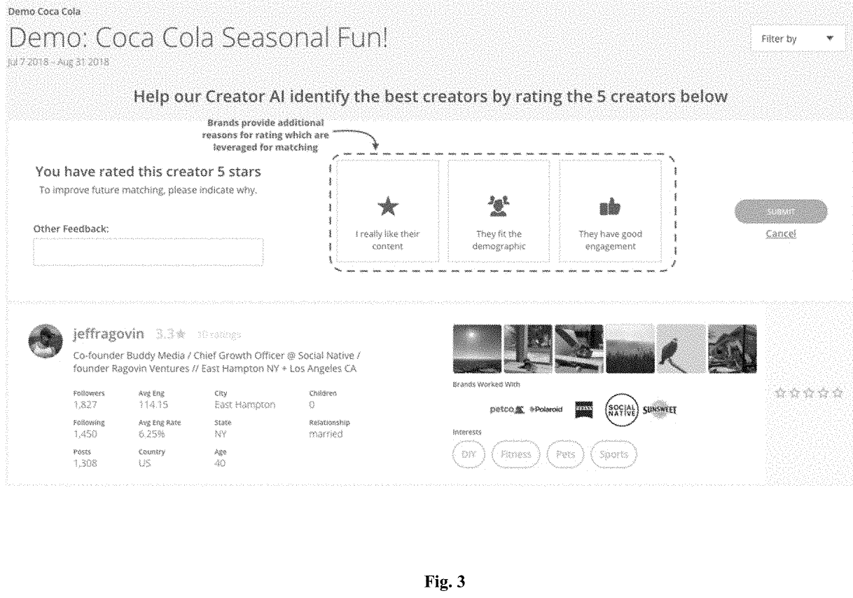

FIG. 3 shows a non-limiting example of an interface for selecting a reason for an external creator rating. As shown, the exemplary reasons for an external creator rating comprise rating the content of a creator, rating the demographic of the creator, and rating the engagement of the creator. Alternatively, in some embodiments, the reasons for an external creator rating comprise any additional feedback. As shown, an interface for selecting the exemplary reasons for an external creator rating further comprises a username of the creator, a description of the creator, a location of the creator, a number of creator followers, a number of created posts, a country, an age, a relationship, a number of children, an interest of the creator, an engagement rate, an average engagement rate, and a brand worked on by the creator.

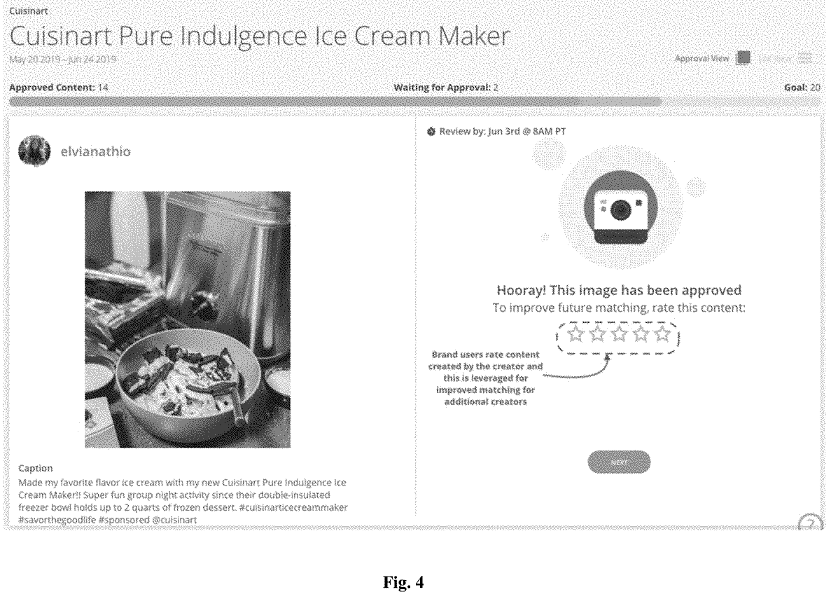

FIG. 4 shows a non-limiting example of an interface for selecting the external content rating. As shown, the exemplary interface for selecting the external content rating comprises a client name, a project name, a creator username, a number of approved creator content, a number of creator content waiting for approval, a goal number of creator content, a product image, a product image caption, a reviewed-by date, and an icon to rate the content.

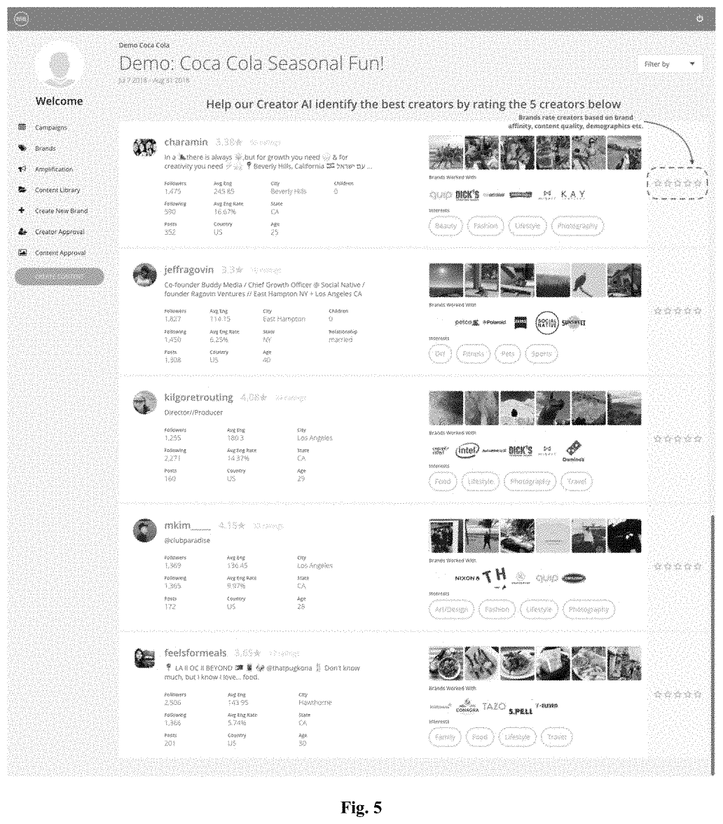

FIG. 5 shows a non-limiting example of an interface for selecting the external creator rating. As seen, the exemplary interface for selecting the external creator rating comprises a username of the creator, a description of the creator, a location of the creator, a number of creator followers, a number of created posts, a country, an age, a relationship, a number of children, an interest of the creator, an engagement rate, an average engagement rate, and a brand worked on by the creator for one or more creators.

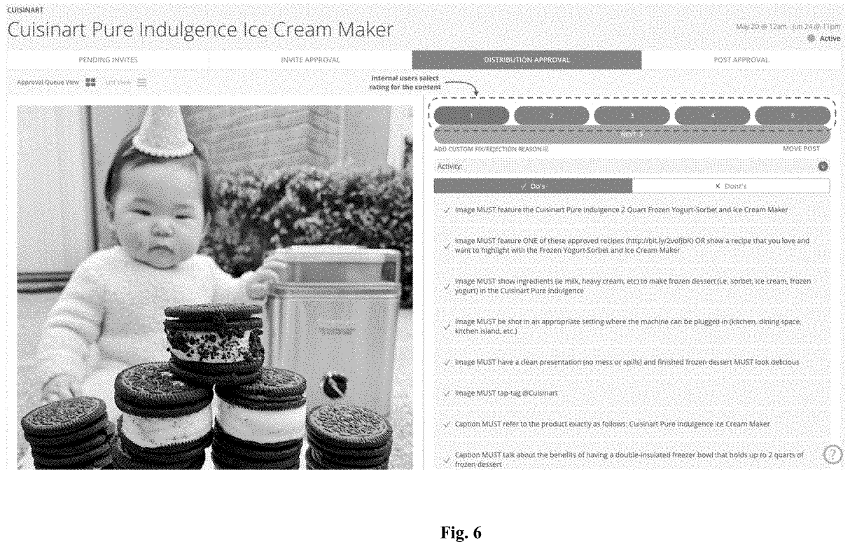

FIG. 6 shows a non-limiting example of an interface for selecting the rating of an internal content rating. As shown, the exemplary interface for selecting the rating of an internal content rating comprises a content image, a rating selection panel, a do's list and a don'ts list. As shown, the rating selection panel comprises selections from 1-5. In some embodiments, the rating selection panel comprises selections from 1-3, 1-4, 1-5, 1-6, 1-7, 1-8, 1-9, 1-10 or more selections. In some embodiments, a selection of 1 is a positive selection indicating satisfaction with the internal content. In some embodiments, a selection of 1 is a negative selection indicating a lack of satisfaction with the internal content. As shown, the do's list comprises a list of requirements for the internal content. In some embodiments, the don'ts list comprises a list of negative requirements of the internal content.

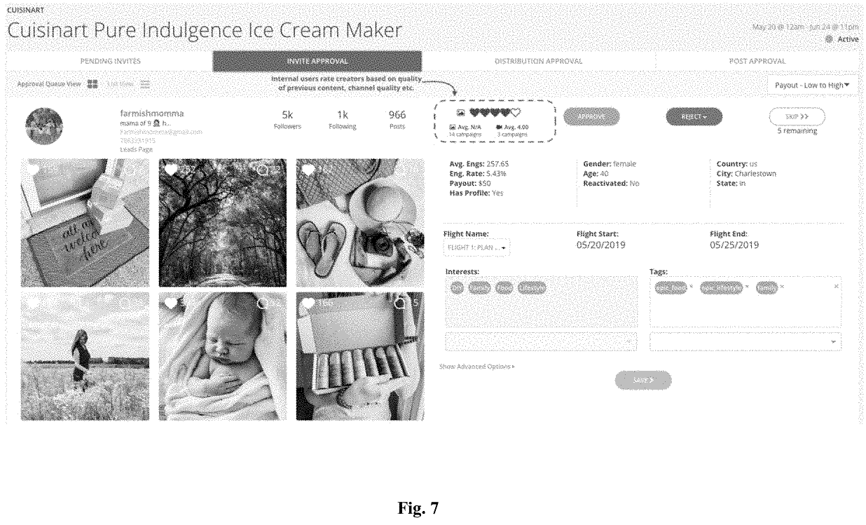

FIG. 7 shows a non-limiting example of an interface for selecting the internal content rating. As shown, the interface for selecting the internal content rating comprises a creator username, a creator email address, a customer, a project name, a number of creator followers, a number of creator posts, a number of engagements, an creator engagement rate, a creator gender, a creator age, a creator location, a creator interest, a creator tag, and a creator content rating selection pane. As shown the creator content rating selection pane allows internal users to select a quality associated with the content. As shown, the internal user can further approve or reject the content.

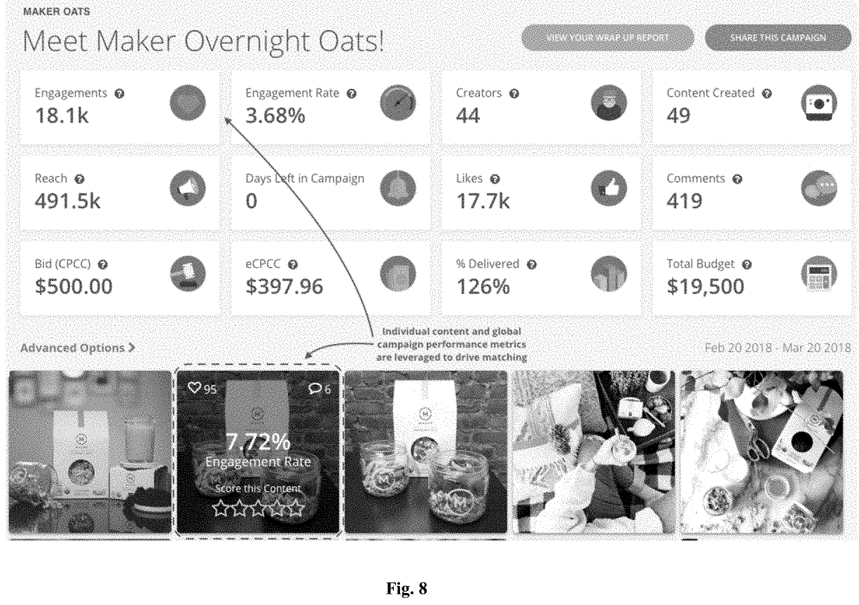

FIG. 8 shows a non-limiting example of an interface for viewing content performance data. As shown the exemplary interface for viewing content performance data comprises a client name, a project name, an engagements indication, an engagement rate indication, a number of creators, a number of content created, a number of people reached with the content, a number of days left in the campaign, a number of likes, a number of comments, a bid price, an eCPPC price, a percent delivered, and a total budget. In some embodiments, individual content and global campaign performance metrics are leveraged to drive matching.

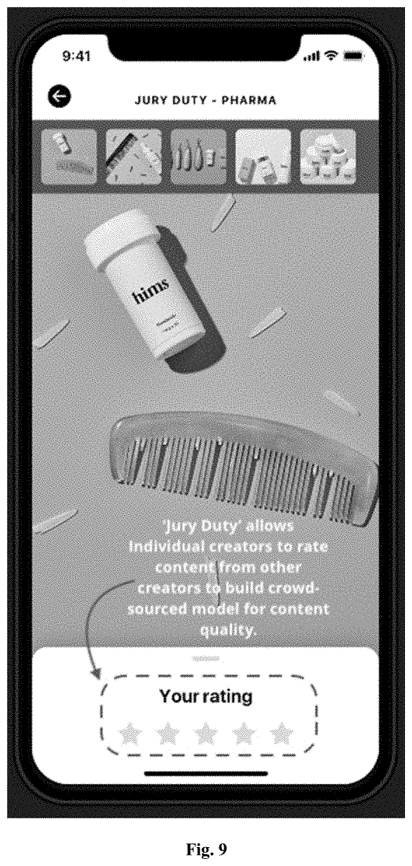

FIG. 9 shows a non-limiting example of an interface for selecting a crowd sourced content rating. As shown, the exemplary interface for selecting a crowd sourced content rating comprises an image and a rating bar. In some embodiments, the rating bar allows a creator to rate content from other creators to build a crowd sourced model of quality. As shown, the rating bar allows a creator to enter a rating of 1-5, wherein 1 is a poor rating and 5 is an excellent rating. Alternatively, in some embodiments, the rating bar allows a creator to enter a rating of 1-3, 1-6, 1-7, 1-8 or 1-10.

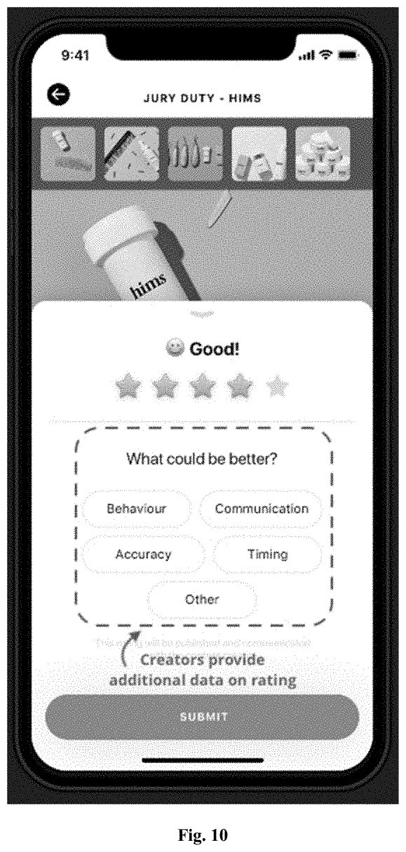

FIG. 10 shows a non-limiting example of an interface for selecting a reason for a crowd sourced content rating. As shown the exemplary interface for selecting a reason for a crowd sourced content rating comprises the rating bar, a feedback form, and a submit button. Further, as shown the feedback form allows a creator to select one or more feedback reasons of what could have been better with the content. In some embodiments, the one or more feedback reasons comprise a behavior, a communication, an accuracy, a timing, or another reason.

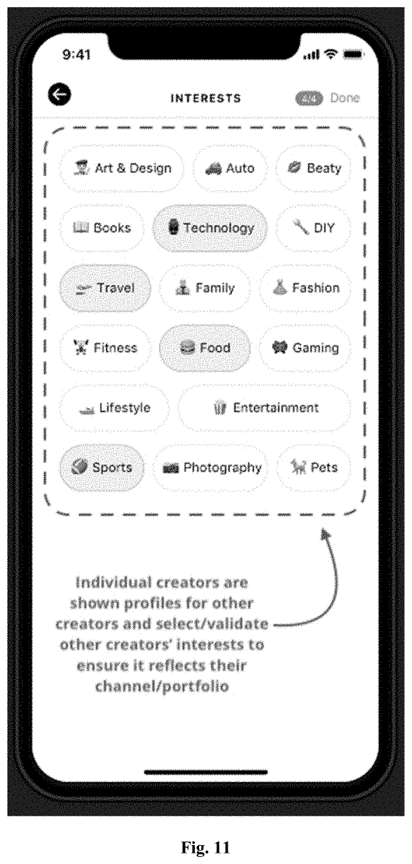

FIG. 11 shows a non-limiting example of an interface for selecting the crowd-sourced interest mapping. As seen the exemplary interface for selecting the crowd-sourced interest mapping allows a creator to select and/or validate other creators' interest to ensure their interests match their respective portfolios. As shown, the interests comprise art and design, auto, beauty, books, technology, DIY, travel, family, fashion, fitness, food, gaming, lifestyle, entertainment, sports, photography, and pets.

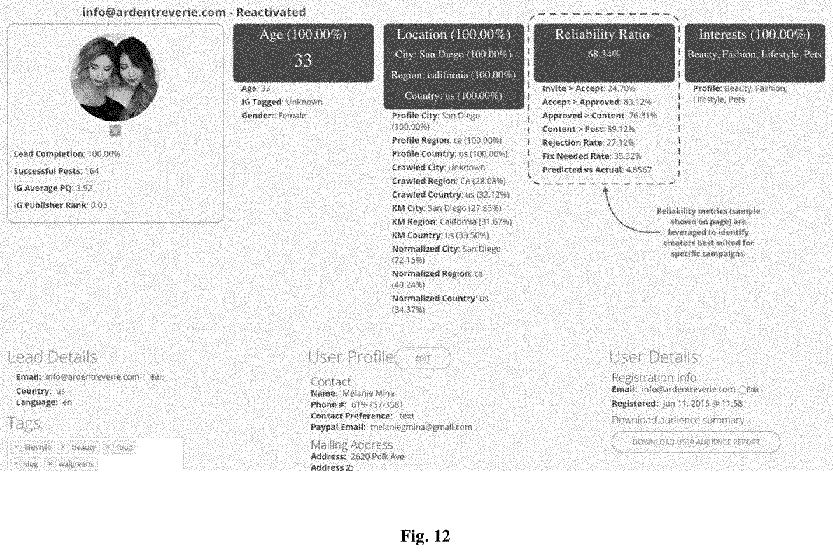

FIG. 12 shows a non-limiting example of an interface for displaying a reliability score. As seen the exemplary interface for displaying a reliability score shows a creator email, a creator image, a lead completion percentage, a number of successful posts, an IG average PQ, an IG publisher rank, a creator location, a creator tag, a creator age, a creator gender, a creator reliability ratio, a creator invite to accept ratio, a creator accept to approved ratio, an approved to creator content ratio, a creator content to post ratio, a creator rejection rate, a creator fix needed rate, a creator predicted vs actual value, a profile tag, an interest tag, a creator registration date, a creator name, a creator mailing address, and a creator phone number. In some embodiments, the creator invite to accept ratio reflects a ratio between a number invitations sent to a creator to provide a content for a campaign and a number of campaigns accepted by the creator. In some embodiments, the creator accept to approved ratio, reflects a ratio between a number of campaigns accepted and a number of campaigns approved for initiation. In some embodiments, approved to creator content ratio reflects a ratio between a number of campaigns approved for initiation and a number of campaigns created in some embodiments, the creator content to post ratio reflects a ratio a number of campaigns created and a number of posts created. In some embodiments, the creator rejection rate reflects a number of contents provided by the creator that were rejected by the buyer. In some embodiments, the creator fix needed rate reflects a number of amendments required by the buyer. In some embodiments, the reliability ratio is calculated based on one or more of the creator invite to accept ratio, creator accept to approved ratio, approved to creator content ratio, creator content to post ratio, creator rejection rate, or the creator fix needed rate. In some embodiments, the creator predicted vs actual value displays a positive or negative difference between a predicted reliability ratio and the calculated reliability ratio. In some embodiments, the predicted reliability ratio is determined based on the previous content, the creator location, the creator tag, the creator age, the creator gender, the profile tag, an interest tag, the creator registration date, the creator name, the creator mailing address, the creator phone number, or any combination thereof.

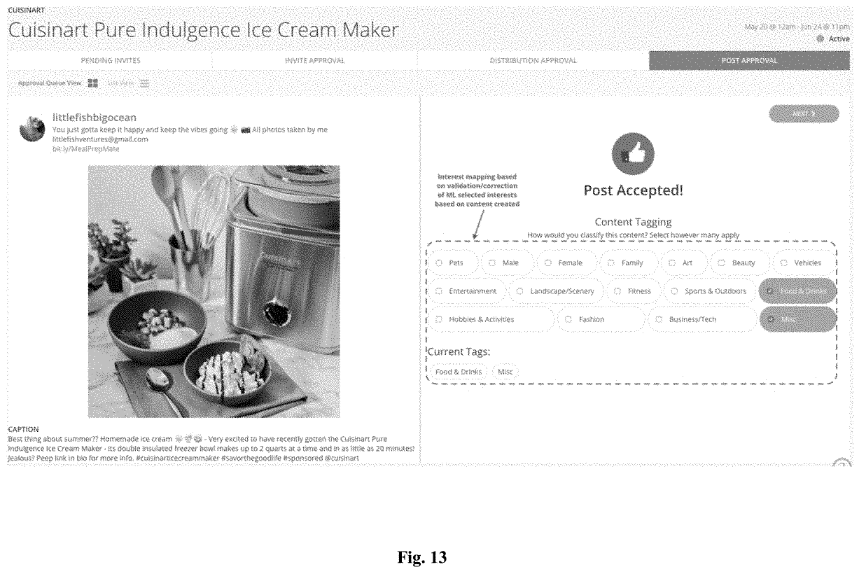

FIG. 13 shows a non-limiting example of an interface for selecting an internal interest. As shown, the exemplary interface for selecting an internal interest comprises a client name, a project name, a creator name, a creator blurb, a content image, a content caption, a post accepted notification, and a content tagging input region. As shown, the content tagging input region enables interest mapping based on validation/correction of ML selected interest based on created content. Further, as shown the content tags comprise a pet, a male, a female, a family, an art, a beauty, a vehicle, an entertainment, a landscape/scenery, a fitness, a sports/outdoors, a food and drinks, a hobby and activity, a fashion, a business/tech, and a miscellaneous tag.

In some embodiments, the machine-learning model herein predictively identifies and matches the best creators for a specific brief. In some embodiments, this is a supervised machine-learning model that is trained using extensive data inputs (listed) to predict the best creators based on the attributes of the brief. In some embodiments, this model is measured against a verified test set that consists of creator matches for a variety of briefs. In some embodiments, the machine has been trained to achieve a high-degree of accuracy against the test set. Additionally, in some embodiments, the model also adjusts its predictions based on real-time selections that are made by the buyer during the creator selection process.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by 10%, 5%, or 1%, including increments therein.

### Machine Learning

In some embodiments, machine learning algorithms are utilized to optimize a computer's effectiveness in identifying content creators. In some embodiments, machine learning algorithms are utilized by the identification module to process the request for media generation and the plurality of content creator data to identify one or more content creators to perform the request for media generation. In some embodiments, the machine learning algorithms utilized by the identification module employ one or more forms of labels including but not limited to human annotated labels and semi-supervised labels. The human annotated labels can be provided by a hand-crafted heuristic. For example, the hand-crafted heuristic can comprise examining differences between public and county records. The semi-supervised labels can be determined using a clustering technique to find properties similar to those flagged by previous human annotated labels and previous semi-supervised labels. The semi-supervised labels can employ a XGBoost, a neural network, or both.

In some embodiments, machine learning algorithms are utilized by the identification module to process the request for media generation and the plurality of content creator data to identify one or more content creators to perform the request for media generation, using a distant supervision method. The distant supervision method can create a large training set seeded by a small hand-annotated training set. The distant supervision method can comprise positive-unlabeled learning with the training set as the ‘positive’ class. The distant supervision method can employ a logistic regression model, a recurrent neural network, or both. The recurrent neural network can be advantageous for Natural Language Processing (NLP) machine learning.

Examples of machine learning algorithms can include a support vector machine (SVM), a naïve Bayes classification, a random forest, a neural network, deep learning, or other supervised learning algorithm or unsupervised learning algorithm for classification and regression. The machine learning algorithms can be trained using one or more training datasets.

In some embodiments, the machine learning algorithm utilizes regression modeling, wherein relationships between predictor variables and dependent variables are determined and weighted. In some embodiments, a machine learning algorithm is used to select catalogue images and recommend project scope. A non-limiting example of a multi-variate linear regression model algorithm is seen below: probability=A₀+A₁(X₁)+A₂(X₂)+A₃(X₃)+A₄(X₄)+A₅(X₅)+A₆(X₆)+A₇(X₇) . . . wherein A₁ (A₁, A₂, A₃, A₄, A₅, A₆, A₇, . . . ) are “weights” or coefficients found during the regression modeling; and Xᵢ (X₁, X₂, X₃, X₄, X₅, X₆, X₇, . . . ) are data collected from the User. Any number of Aᵢ and Xᵢ variable can be included in the model. For example, in a non-limiting example wherein there are 7 Xᵢ terms, X₁ is the number of creators and X₂ is the number of content campaigns. In some embodiments, the programming language “R” is used to run the model.

In some embodiments, training comprises multiple steps. In a first step, an initial model is constructed by assigning probability wrights to predictor variables. In a second step, the initial model is used to “recommend” content creators. In a third step, the validation module accepts identification data and feeds back the verified data to identification module calculation. At least one of the first step, the second step, and the third step can repeat one or more times continuously or at set intervals.

In some embodiments, a brief creator score based the information in the brief, and weights applied to the internal content rating, the internal creator rating, the external creator rating, the external content rating, the content performance, the crowd-sourced content rating, the reliability score, and creator social metrics. In some embodiments, the weights comprise predictor variables.

### Computing System

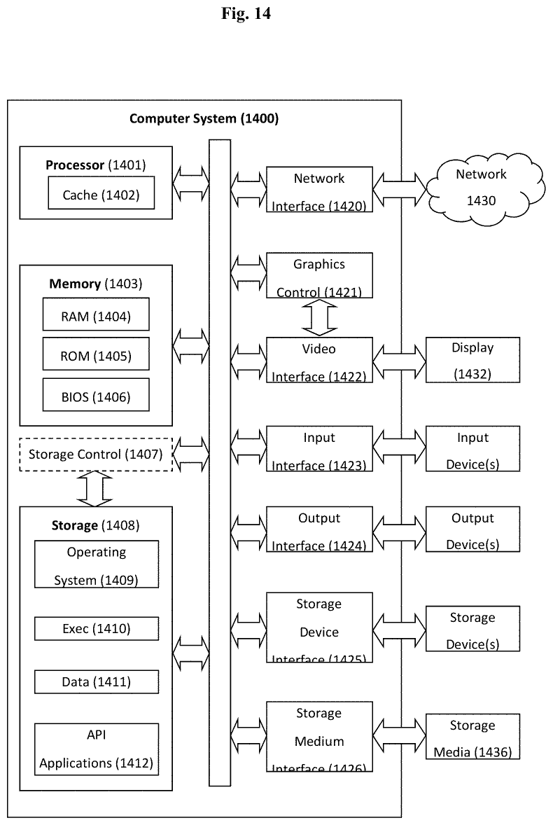

Referring to FIG. 14, a block diagram is shown depicting an exemplary machine that includes a computer system 1400 (e.g., a processing or computing system) within which a set of instructions can execute for causing a device to perform or execute any one or more of the aspects and/or methodologies for static code scheduling of the present disclosure. The components in FIG. 14 are examples only and do not limit the scope of use or functionality of any hardware, software, embedded logic component, or a combination of two or more such components implementing particular embodiments.

Computer system 1400 may include one or more processors 1401, a memory 1403, and a storage 1408 that communicate with each other, and with other components, via a bus 1440. The bus 1440 may also link a display 1432, one or more input devices 1433 (which may, for example, include a keypad, a keyboard, a mouse, a stylus, etc.), one or more output devices 1434, one or more storage devices 1435, and various tangible storage media 1436. All of these elements may interface directly or via one or more interfaces or adaptors to the bus 1440. For instance, the various tangible storage media 1436 can interface with the bus 1440 via storage medium interface 1426. Computer system 1400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 1400 includes one or more processor(s) 1401 (e.g., central processing units (CPUs) or general purpose graphics processing units (GPGPUs)) that carry out functions. Processor(s) 1401 optionally contains a cache memory unit 1402 for temporary local storage of instructions, data, or computer addresses. Processor(s) 1401 are configured to assist in execution of computer readable instructions. Computer system 1400 may provide functionality for the components depicted in FIG. 14 as a result of the processor(s) 1401 executing non-transitory, processor-executable instructions embodied in one or more tangible computer-readable storage media, such as memory 1403, storage 1408, storage devices 1435, and/or storage medium 1436. The computer-readable media may store software that implements particular embodiments, and processor(s) 1401 may execute the software. Memory 1403 may read the software from one or more other computer-readable media (such as mass storage device(s) 1435, 1436) or from one or more other sources through a suitable interface, such as network interface 1420. The software may cause processor(s) 1401 to carry out one or more processes or one or more steps of one or more processes described or illustrated herein. Carrying out such processes or steps may include defining data structures stored in memory 1403 and modifying the data structures as directed by the software.

The memory 1403 may include various components (e.g., machine readable media) including, but not limited to, a random access memory component (e.g., RAM 1404) (e.g., static RAM (SRAM), dynamic RAM (DRAM), ferroelectric random access memory (FRAM), phase-change random access memory (PRAM), etc.), a read-only memory component (e.g., ROM 1405), and any combinations thereof. ROM 1405 may act to communicate data and instructions unidirectionally to processor(s) 1401, and RAM 1404 may act to communicate data and instructions bidirectionally with processor(s) 1401. ROM 1405 and RAM 1404 may include any suitable tangible computer-readable media described below. In one example, a basic input/output system 1406 (BIOS), including basic routines that help to transfer information between elements within computer system 1400, such as during start-up, may be stored in the memory 1403.

Fixed storage 1408 is connected bidirectionally to processor(s) 1401, optionally through storage control unit 1407. Fixed storage 1408 provides additional data storage capacity and may also include any suitable tangible computer-readable media described herein. Storage 1408 may be used to store operating system 1409, executable(s) 1410, data 1411, applications 1412 (application programs), and the like. Storage 1408 can also include an optical disk drive, a solid-state memory device (e.g., flash-based systems), or a combination of any of the above. Information in storage 1408 may, in appropriate cases, be incorporated as virtual memory in memory 1403.

In one example, storage device(s) 1435 may be removably interfaced with computer system 1400 (e.g., via an external port connector (not shown)) via a storage device interface 1425. Particularly, storage device(s) 1435 and an associated machine-readable medium may provide non-volatile and/or volatile storage of machine-readable instructions, data structures, program modules, and/or other data for the computer system 1400. In one example, software may reside, completely or partially, within a machine-readable medium on storage device(s) 1435. In another example, software may reside, completely or partially, within processor(s) 1401.

Bus 1440 connects a wide variety of subsystems. Herein, reference to a bus may encompass one or more digital signal lines serving a common function, where appropriate. Bus 1440 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1400 may also include an input device 1433. In one example, a user of computer system 1400 may enter commands and/or other information into computer system 1400 via input device(s) 1433. Examples of an input device(s) 1433 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 1433 may be interfaced to bus 1440 via any of a variety of input interfaces 1423 (e.g., input interface 1423) including, but not limited to, serial, parallel, game port, USB, FIREWIRE, THUNDERBOLT, or any combination of the above.

In particular embodiments, when computer system 1400 is connected to network 1430, computer system 1400 may communicate with other devices, specifically mobile devices and enterprise systems, distributed computing systems, cloud storage systems, cloud computing systems, and the like, connected to network 1430. Communications to and from computer system 1400 may be sent through network interface 1420. For example, network interface 1420 may receive incoming communications (such as requests or responses from other devices) in the form of one or more packets (such as Internet Protocol (IP) packets) from network 1430, and computer system 1400 may store the incoming communications in memory 1403 for processing. Computer system 1400 may similarly store outgoing communications (such as requests or responses to other devices) in the form of one or more packets in memory 1403 and communicated to network 1430 from network interface 1420. Processor(s) 1401 may access these communication packets stored in memory 1403 for processing.

Examples of the network interface 1420 include, but are not limited to, a network interface card, a modem, and any combination thereof. Examples of a network 1430 or network segment 1430 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 1430, may employ a wired and/or a wireless mode of communication. In general, any network topology may be used.

Information and data can be displayed through a display 1432. Examples of a display 1432 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1432 can interface to the processor(s) 1401, memory 1403, and fixed storage 1408, as well as other devices, such as input device(s) 1433, via the bus 1440. The display 1432 is linked to the bus 1440 via a video interface 1422, and transport of data between the display 1432 and the bus 1440 can be controlled via the graphics control 1421. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 1432, computer system 1400 may include one or more other peripheral output devices 1434 including, but not limited to, an audio speaker, a printer, a storage device, and any combinations thereof. Such peripheral output devices may be connected to the bus 1440 via an output interface 1424. Examples of an output interface 1424 include, but are not limited to, a serial port, a parallel connection, a USB port, a FIREWIRE port, a THUNDERBOLT port, and any combinations thereof.

In addition or as an alternative, computer system 1400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein.

Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft Windows®, Apple Mac OS X®, UNIX °, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with the digital processing device, such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java™, and Unity®.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

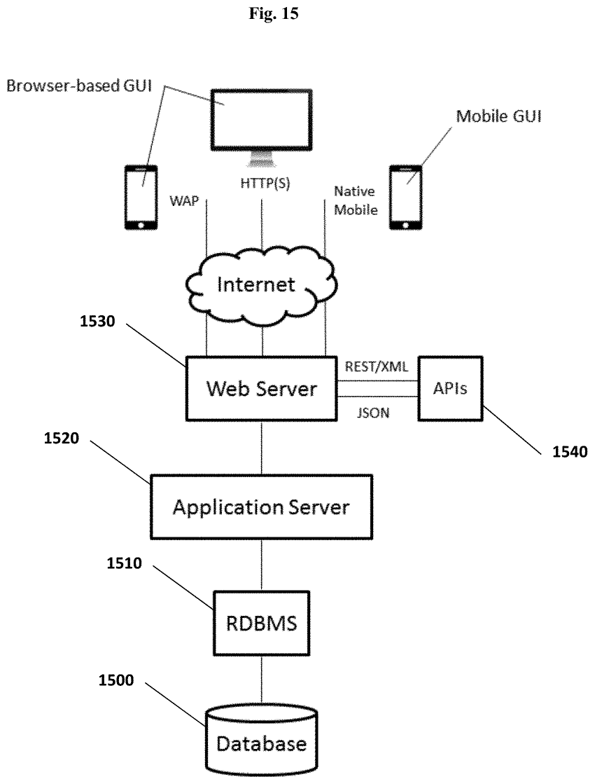

Referring to FIG. 15, in a particular embodiment, an application provision system comprises one or more databases 1500 accessed by a relational database management system (RDBMS) 1510. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 1520 (such as Java servers, .NET servers, PHP servers, and the like) and one or more web servers 1530 (such as Apache, IIS, GWS and the like). The web server(s) optionally expose one or more web services via app application programming interfaces (APIs) 1540. Via a network, such as the Internet, the system provides browser-based and/or mobile native user interfaces.

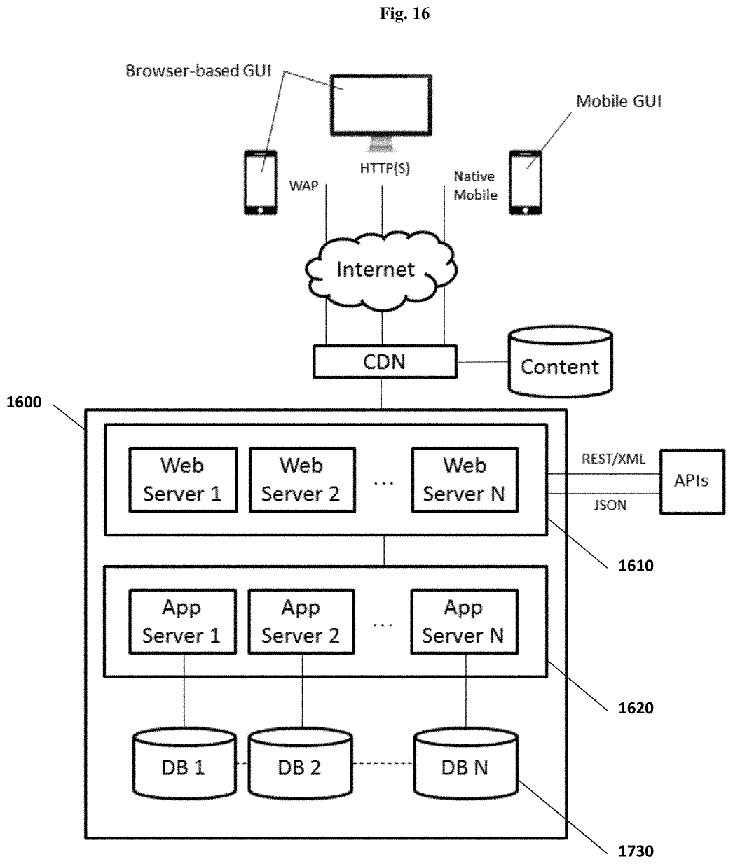

Referring to FIG. 16, in a particular embodiment, an application provision system alternatively has a distributed, cloud-based architecture 1600 and comprises elastically load balanced, auto-scaling web server resources 1610 and application server resources 1620 as well synchronously replicated databases 1630.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of XXX information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

### EXAMPLES

The following illustrative example is representative of embodiments of the software applications, systems, and methods described herein and are not meant to be limiting in any way.

### Example 1

In one example, a buyer creates a brief comprising a description (e.g. a text-form explanation of advertising content they wish to purchase), a target interest (e.g. the type of audience), a required content type (e.g. image, short-form video, long-form video, reviews, animated gif), a target demographic (e.g. age, gender, location), and any additional information about the campaign, such as required product.

Based on the information in the brief, the system automatically identifies the best creators for the campaign by applying a ML process to generate a brief creator score that is unique for each creator brief/creator combination. The system then leverages creator/content metrics and scores collected via performance data, internal/external ratings and crowd-sourced creator/content annotation.

The buyer then accepts or denies a content from a creator. This acception or denial provides additional data to the system to recalculate the brief creator score based on such selections to suggest additional creators. The brief creator score is continually recalculated based on the selections, to provide constant improvement in the list of top creators for the brief.

### Example 2

Best Pet Toys creates a brief comprising a description of a video they are requesting to advertise a super-chewy dog toy to male young adults in California.

Based on the information in the brief, the system automatically identifies Bob and Joe as the best creators for the campaign based on a brief creator score that is unique for each creator brief/creator combination. The system then leverages creator/content metrics and scores collected via performance data, internal/external ratings and crowd-sourced creator/content annotation.

The buyer then accepts Joe as a creator. This acception or denial provides additional data to the system to recalculate the brief creator score for Joe and Bob to suggest additional creators in the future. The brief creator score is continually recalculated based on the selections, to provide constant improvement in the list of top creators for the brief.

### Example 3

In one example, a buyer creates a brief comprising a description (e.g. a text-form explanation of advertising content they wish to purchase), a target interest (e.g. the type of audience), a required content type (e.g. image, short-form video, long-form video, reviews, animated gif), a target demographic (e.g. age, gender, location), and any additional information about the campaign, such as required product.

The system then selects one or more creators based on a brief creator score that is unique for each creator brief/creator combination and is based the information in the brief, and weights applied to the internal content rating, the internal creator rating, the external creator rating, the external content rating, the content performance, the crowd-sourced content rating, the reliability score, and creator social metrics. The weights are constantly updated by a machine learning process as clients select, rate, and score each creator and/or their content.

### Example 4

Best Pet Toys creates a brief comprising a description of a video they are requesting to advertise a super-chewy dog toy to male young adults in California.

Based on the information in the brief, the system automatically identifies Bob and Joe as the best creators for the campaign based on a brief creator score that is unique for each creator brief/creator combination. The system then leverages creator/content metrics and scores collected via performance data, internal/external ratings and crowd-sourced creator/content annotation.

Although Bob has a higher brief creator score based the information in the brief, and weights applied to the internal content rating, the internal creator rating, the external creator rating, the external content rating, the content performance, the crowd-sourced content rating, the reliability score, and creator social metrics, the buyer selects Joe as a creator. As such, the weights applied to the internal content rating, the internal creator rating, the external creator rating, the external content rating, the content performance, the crowd-sourced content rating, the reliability score, and creator social metrics are updated using a machine learning algorithm to select Joe more often than Bob for future campaigns similar to the super-chewy dog toy campaign.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. A computer-implemented system comprising: a computer-readable storage device coupled to the at least one processor and having instructions stored thereon which, when executed by the at least one processor, cause the at least one processor to perform operations comprising:
a) receiving, from a user interface, a request for media generation;
b) determining a plurality of content creators based on the request for media generation;
c) training a machine learning algorithm using the plurality of content creators;
d) assigning unrefined weights to a predictor variable of the machine learning algorithm;
e) processing the request for media generation through the machine learning algorithm to determine a plurality of recommended options, the recommended options comprising one or more of the plurality of content creators;
f) providing the recommended options to the user interface;
g) receiving, from the user interface, a data set comprising selections of the one or more of the plurality of content creators;
h) adjusting the predictor variables of the machine learning algorithm based on the selections of the one or more of the plurality of content creators;
i) feeding back the data set and the request for media generation through the machine learning algorithm.

2. The system of claim 1, wherein the request for media generation is a request for the generation of any form of a campaign media.

3. The system of claim 1, wherein the request for media generation comprises one or more of the following: a description of the media, an interest which the media intends to target, a demographic which the media intends to target, and a required content type.

4. The system of claim 1, wherein each of the plurality of content creators are associated with a content creator data comprising one or more of a creator score and an interest graph.

5. The system of claim 4, wherein the creator score comprises one or more of the following: a content score, an internal creator score, an external creator score, creator social metrics and a reliability score.

6. The system of claim 4, wherein the interest graph comprises one or more of the following:
crowd sourced interest mapping and internal interest mapping.

7. The system of claim 4, wherein the predictor variables comprise weights associated with the content creator data.

8. The system of claim 5, wherein the predictor variables comprise weights associated with the content creator data.

9. The system of claim 1, wherein the request for media generation is associated with a content score.

10. The system of claim 9, wherein the content score comprises one or more of the following: an internal content rating, an external content rating, content performance data, and a crowd sourced content rating.

11. The system of claim 9, wherein the predictor variables comprise weights associated with the content score.

12. The system of claim 1, wherein the machine learning algorithm is supervised.
